(19) United States
(12) Patent Application Publication
(10) Pub. No.: US 2006/0070947 A1
(43) Pub. Date: Apr. 6, 2006

(54) Method and apparatus for treating water

(76) Inventor: Wayne Conrad, Hampton (CA)

Correspondence Address: BERESKIN AND PARR, 40 KING STREET WEST, BOX 401, TORONTO, ON, M5H 3Y2, CA

(21) Appl. No.: 10/527,408

(22) PCT Filed: Sep. 15, 2003
(86) PCT No.: PCT/CA03/01337

§ 371 Date: Mar. 11, 2005

Related U.S. Application Data
(60) Provisional application No. 60/410,821, filed on Sep. 16, 2002.

(51) Int. Cl. B01D 35/14; C02F 3/00

(52) U.S. Cl. 210/601; 210/86; 210/104; 210/151; 210/257.1; 210/258; 210/263; 210/663

(57) ABSTRACT

A water treatment apparatus includes a sand filter and a second stage purification step (e.g. ozonation). The sand filter is constructed as a plurality of individual components that are in fluid flow communication. At least that uppermost individual component of the sand filter is removable for cleaning.

### FIELD OF THE INVENTION

This application relates to water treatment apparatus that utilize sand or other packed material as a filtration mechanism.

### BACKGROUND OF THE INVENTION

Several different systems are known for treating water. Typically, these systems employ filtration to remove particulate material from the water, and a purification step to kill bacteria viruses and the like in the water, such as treatment with ozone, peroxide or ultraviolet radiation. As a result of these steps, potable water may be produced.

One treatment system that is known in the art is the sand filtration system. The systems are used treating water that is used in a house. Pursuant to the system, water is passed through and extended bed of sand. For example, the bed of sand may be three to four feet deep. One disadvantage the system is that it is and must periodically be cleaned or replaced. The sand is typically housed in a sealed container to prevent odors from the accumulated material that has been filtered from the sand from penetrating into a house. When the container is open to clean or replace the sand, these odors are released into the house. Further, replacing or cleaning the sand is a time-consuming job.

### SUMMARY OF THE INVENTION

In accordance with the instant invention, an improved sand filtration system has been developed. In accordance with one aspect of the instant invention, the bed of sand is provided in at least two, and preferably a plurality, of individual containers.

The total length of the bed of sand that is employed in accordance with the instant invention is preferably for about 30 to about 48 inches. Typically, only about the top 8 inches of sand captures a substantial portion (e.g. over 90 percent and, in some cases, about 99 percent) of the material removed by the filtration process. Therefore, if the upper layer of sand is periodically cleaned or replaced, the remainder of the sand need not be replaced. In accordance with this embodiment of the invention, the bed of sand is divided into at least two portions. The first portion of the bed of sand that the water encounters (e.g. the top layer) is provided in a container that is removable from the rest of the apparatus. For example, the bed of sand may be provided in at least two containers that are removable mounted in a housing. Accordingly, when it is necessary to clean or replace the first portion of the bed of sand, the first portion of the bed of sand may be removed from the housing as a discreet element. Thus, a user need only remove one portion of the bed of sand reducing the mess that may be created in this process.

In accordance with the instant invention, the remaining portion of the bed of sand may be provided in a plurality of discrete containers that are removably mounted in the apparatus so as to permit each portion of the bed of sand to be replaced as desired.

Preferably, each container is sealed when removed from the apparatus. In this way, individual portions of the bed of sand may be replaced without releasing any odors into a house. The containers may be sealed upon removal from the apparatus by, for example, a check valve, ball valve or other closeable aperture that is sealed automatically upon the withdrawal of the container from the apparatus, such as an iris.

In accordance with another embodiment of the instant invention, the filtered water is subjected to a purification step, such as treatment by ultraviolet radiation, or an oxidizer such as ozone. Preferably, the filtered water is subjected to ozonation.

The treated water may be fed directly to in water supply system, such as the clean water supply to a house. Preferably, the treated water is stored so that a quantity of water is available for use at any particular time. In accordance with another embodiment of the instant invention, the water is stored in an unpressurized tank.

In accordance with another embodiment of the instant invention, a biological material is added to the first portion of the sand, when that portion is replaced. A layer of biological and organic material [known in the art as schmutzdecke] forms on top of the sand during use of a sand filter. This layer provides a very effective filtration layer that enhances the performance of a sand filter The addition of biological material so as to expedite the formation of this biological layer of material beneficially enhances the filtration provided by the apparatus.

It will be appreciated that each of these embodiments may be used individually in a water treatment apparatus according to the instant invention, or they may be combined in any particular combination. All such uses are within the scope of this invention.

### DESCRIPTION OF THE DRAWINGS

For a better understanding of the present invention and to show more clearly how it may be carried into effect, reference will now be made by way of example to the accompanying drawings, of the preferred embodiments of the present invention, in which:

FIG. 1 is a is a schematic drawing of a first embodiment of a water treatment apparatus according to the instant invention;

FIG. 2 is a schematic drawing of a second embodiment of a water treatment apparatus according to the instant invention;

FIG. 3 is schematic drawing of a third embodiment of a water treatment apparatus according to the instant invention; and,

FIG. 4 is an alternate embodiment of the treated water storage tank.

### DESCRIPTION OF THE PREFERRED EMBODIMENT

The water treatment apparatus of the instant invention may be used to treat a portion, and preferably all, of the water that is provided to a house, apartment, cottage or other dwelling. Accordingly, the apparatus may be used to treat municipally treated water that is provided to a house, or well or lake water that is provided to a dwelling.

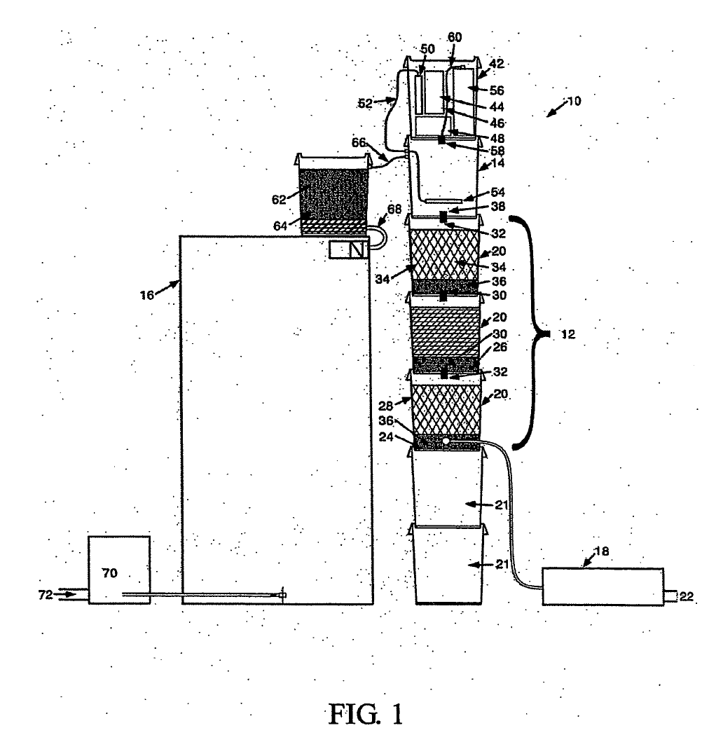

Referring to FIG. 1, a water treatment apparatus 10 comprises a sand filter 12, a purification chamber 14 and a storage tank 16. The embodiment disclosed in FIG. 1 utilizes municipally treated water. As such, the water is provided to sand filter 12 under pressure. Preferably, the water is depressurized to, for example, less than 20 psi and, preferably, less than 5 psi. By reducing the pressure of the system, the construction of the apparatus is simplified. In particular, the seals that required for the different elements, such as the individual containers of sand filter 12, are simplified. In addition, the components of the system may be made from thinner materials. The pressure of the incoming water may be reduced by any means known in the art. Optionally, a pressure meter, such as metering valve and solenoid 18, may be provided at any point in the system so as to monitor the internal pressure of the water supply.

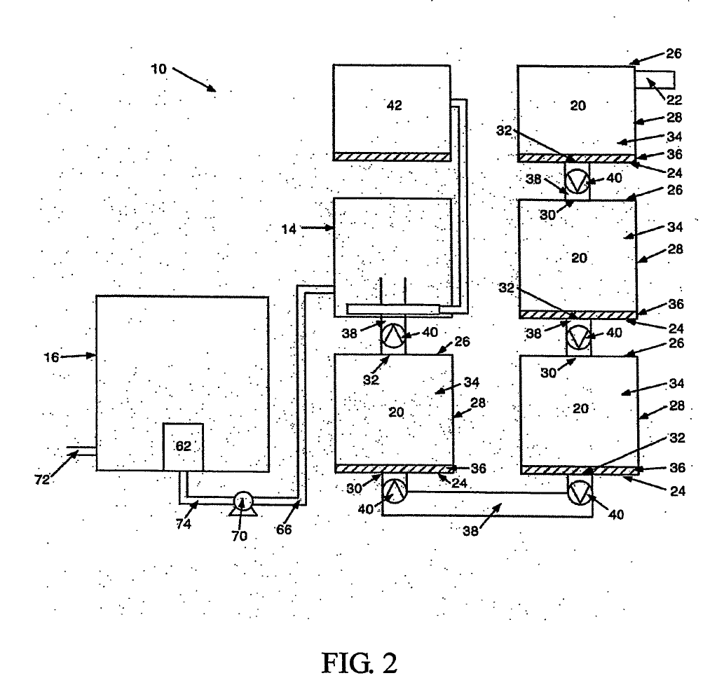

In accordance with the instant invention, sand filter 12 is divided into at least two containers 20 and, preferably, into a plurality of containers 20. The water flows sequentially through each container 20 so that, after the water has passed through each container 20, it has passed through the sufficient depth of sand to achieve the desired degree of filtration. As shown in FIG. 1, water inlet 22 is provided at the bottom of sand filter 12. Accordingly, the water flows upwardly through sand filter 12. However, as shown in FIG. 2, water inlet 22 may be provided at the top of the sand filter 12. In the embodiment of FIG. 1, sand filter 12 comprises 3 containers 20. In this embodiment, lower containers 21 are provided merely as a platform for containers 20 so as to raise first container 20 (which is positioned immediately above containers 21) to a level above the ground to facilitate the removal of first container 20.

By constructing sand filter 12 from a plurality of individual containers 20, the sand may be replaced one portion at a time. Preferably, each container 20 holds an amount of sand that may be easily moved by a single person. Thus, to clean or removal the sand, each container 20 may be removed from apparatus 10 one at a time, or all at the same time, so as to clean or replace all of the sand. However, it will be appreciated that only one more of the upstream containers where the bulk of the filtration occurs may be replaced on a regular basis.

Container 20 may be of any shape known in the art and typically has a bottom 24, a top 26 and sidewalls 28 extending between bottom 24 and top 26. Container 20 has a water inlet 28 and an outlet 30 so as to permit water to flow through sand 34 that is positioned in container 20. A passageway 38 may be optionally provided to connect outlet 32 of one container 20 with inlet 30 of the container 20 that is immediately downstream. Alternately, the downstream end of the outlet 32 of one container 20 may matingly engage the upstream end of an inlet 30 of the adjacent downstream container 20. Sand 34 may be retained in containers 20 by any means known in the art so as to prevent sand 34 from exiting container 20 with the flow of water therethrough. For example, in a preferred embodiment, a substrate 36 is provided in the bottom of each container 20. The substrate may be a woven material such as woven polyethylene. The substrate has openings that are sufficiently large to permit water to flow upwardly, or downwardly, therethrough but sufficiently small to retain sand 34 in container 20.

Each container 20 may be provided in a housing that holds each container 20 in position. To remove a particular container 20, the housing may be disassembled or may have access port so as to allow access to container 20. Alternately, no exterior housing may be provided. Instead, may be containers 20 are mechanically linked to each other so as to define a structural unit.

Preferably, each containing 20 is provided in apparatus 10 so as to be sealed upon removal from apparatus 10. Accordingly, a closure member, such as valve 40, may be associated with at least the inlet 30 or outlet 32 which is provided in bottom 24 of each container 20 so as to prevent any water in container 20 from flowing out to through the opening in the bottom 24 of container 20 when container 20 is removed from apparatus 10. More preferably, a valve 40 is provided for each of inlet 30 and outlet 32 so that all of container 20 may be sealed upon its removal from apparatus 10. The closure member may be a valve, iris or the like and may be either manually operated or automatically operated. Preferably, valve 40 is automatically operated upon the removal of container 20 from apparatus 10, such as a check valve or the ball valve. Accordingly, when container 20 is removed from apparatus 10, valve 40 will automatically operate prevent any water in container 20 from flowing out to through bottom 24.

After the water has passed through of sufficient amount of sand 34, the water is next preferably subjected to a purification process. The purification process may be any known in the art to kill viruses and bacteria. The purification process may be oxidation or irradiation, such as with ultraviolet radiation. Preferably, the water is subjected to ozonation. Accordingly, in the embodiment of FIG. 1, a purification chamber 14 comprises an ozonation chamber. As shown in the embodiment of FIG. 1, an electronics module 42 is provided immediately above ozonation chamber 14. It will be appreciated by those skilled in the art that the individual components included an electronics chamber 42 may be provided at any convenient location which is desired. In the embodiment of FIG. 1, electronics until 42 includes a container 44 containing a desiccant 46. Container 44 has an inlet and outlet [not shown]. The outlet is in airflow communication with air pump 48. Air pump 48 has an outlet that is an airflow communication with ozone generator 50. Ozone generator 50 produces ozone, as air is passed there through. Ozone containing air exits generator 50 and passes to sparger 54 by means of passage 52. The ozone containing gas bubbles through the water in chamber 14 and results in an off gas that may accumulate in a headspace at the top of chamber 14. The off gas may exit container 14 by means of outlet 58. The off gas then travels through passage 62 to ozone destructor 56. Thereafter, and the air, from which the ozone has been removed, may be vented to that atmosphere.

Subsequent to ozonation, the water may be fed directly into a household water supply system. In such a case, treated water outlet 66 may be connected to a water supply line for a house or a portion of a house or the like (such as via line 72). Alternately, as shown in FIG. 1, the treated water may be stored in a storage tank 16. Storage tank 16 may be any storage tank known in the art. The dimensions and volume of storage tank 16 may be determined based on the design specifications of the apparatus.

If apparatus 10 is operated under pressure, such as the pressure of a municipal water supply, then storage tank 16 may store the water under elevated pressure. In such an embodiment, the pressure in tank 16 may be sufficient to deliver the water to household supply line 72. A pump 70 may optionally be provided to increase the pressure of the water to the desired level.

In an alternate embodiment, storage tank 16 stores the treated water at a reduced pressure and, preferably, at about atmospheric pressure. The use of an atmospheric storage tank is beneficial since it simplifies the construction and maintenance of storage tank 16. For example, storage tank 16 may be designed to hold a capacity of 40 or more gallons of water. At such dimensions, the cost of a storage tank that operates at an elevated pressure is substantial. In addition, additional design constraints are required to ensure that tank 16 maintains its dimensional integrity throughout the life of apparatus 10. In this embodiment, as shown in FIG. 1, pump 70 is provided downstream from storage tank 16 so as to deliver water to domestic feed line up 72.

In another embodiment, the treated water may be fed through a post ozonation filter 62 prior to entering storage tank 16. For example, as shown in FIG. 1, the treated water may be fed to post filter 62 via passageway 66. Post filter 62 may be of any construction known in the art. If apparatus 10 operates under reduced pressure [i.e. below the pressure supplied by the municipal water supply system], then post filter 62 preferably comprises granular activated carbon 64. In such an embodiment, post filter 62 is preferably positioned above storage tank 16 so as to permit the water to flow into storage tank 16 from post filter 62 by gravity feed, such as by passageway 68.

It will be appreciated that if the water in passageway 66 is at a sufficient pressure, then post filter 62 may be an extruded carbon filter. For example, apparatus 10 may operate an elevated pressure without a pressure reduction valve, such as metering valve 18. Alternately, pump 70 may be provided at upstream of storage tank 16 so that water is delivered to apparatus 10 via pressurized supply line 74. In such a case, post filter 62 may be positioned at any location which is desired, such as in storage tank 16, as shown in FIG. 2, or exterior to, but adjacent the bottom of, storage tank 16.

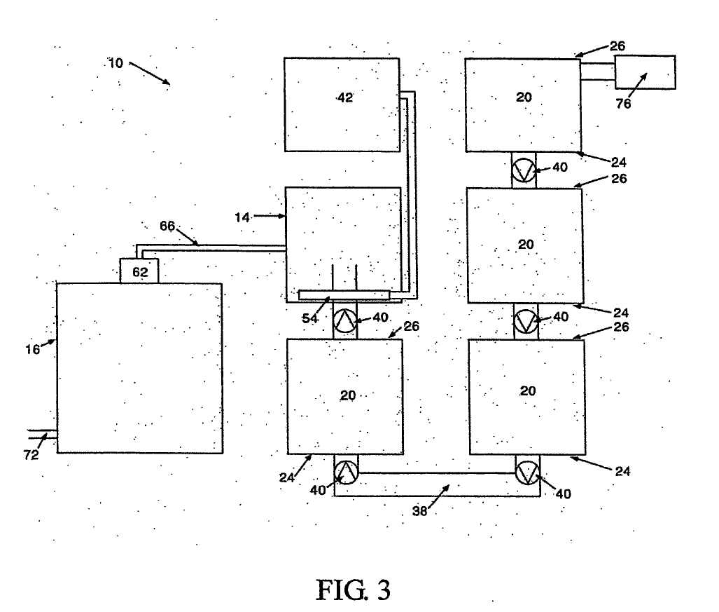

In a further alternate embodiment, water may be delivered to apparatus 10 such as by a pump 76 [see FIG. 3]. For example, the source of water to be treated it may be a well, in which case 0.76 would deliver water from the well to apparatus 10. Alternately, a hand pump could be utilized to deliver water to the apparatus.

During the operation of a sand filter, a layer of biological material tends to form of on top of the sand. This there typically contains bacteria that prey on harmful bacteria, such as those which comprise human pathogens. This layer is known in the art as the schmutzdecke. This layer enhances the filtration characteristics of a sand filter. One disadvantage of current sand filters is that it takes about three to four weeks for the schmutzdecke to form when a new filter is put into service, or when a sand filter is cleaned. In accordance with another embodiment of the instant invention, a cartridge of biological material may be provided. The biological material in the cartridge may be added to one are more containers 20 of sand when the container is placed into service. The biological material helps the formation, or accelerates the formation of the schmutzdecke. The cartridge may be provided as part of container 20, such as in the lid thereof, so as to be positioned above the sand 34. The cartridge may be pierced, or opened, by a handle provided exterior to container 20. Thus, when container 20 is mounted in apparatus 10, the cartridge may be opened to release the biological material without the user coming into contact with the biological material.

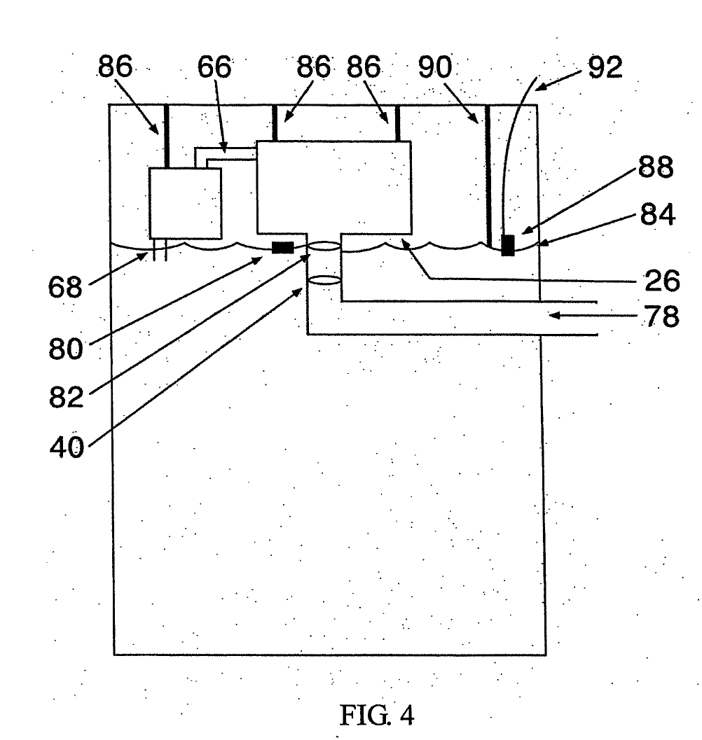

In the alternate embodiment of FIG. 4, purification chamber 14 is positioned in storage tank 16. Purification chamber 14 is positioned upstream of sand filter 12 and in fluid flow communication therewith via passage 78. Post filter 62 is optionally provided downstream from purification chamber 14. In this embodiment, purification chamber 14 is positioned in the upper portion of storage tank 16 so that water level 84 of storage tank 16 controls float valve 82 that is provided in passage 78. In operation, as water is removed from storage tank 16, the water level in storage tank 16 drops causing float 80 to drop thereby opening float valve 82 and causing water to enter purification chamber 14 for treatment. When the water level in storage tank 16 has been raised to the preset level, then float 80 causes float valve 82 to close passage 78 and stop the flow of water into purification chamber 14. Post filter 62 and purification chamber 14 may be held in position by any means know in the art such as by being suspended from the lid of storage tank 16 via brackets 86. Alternately, or in addition, a second float switch 88 may be provided on a bracket 90 and operatively connected to air pump 48 and ozone generator 50 to de-energize air pump 48 and ozone generator 50 when the water level rises to its preset level and the flow of water to purification chamber 14 is terminated.

It will be appreciated that a water treatment apparatus in accordance with the instant invention may use one or more of the embodiments disclosed herein. It will be appreciated by a person skilled in the art that the various embodiment maybe combined to produce a number of different water treatment apparatus, each of which is within the scope of this disclosure.

1. A water treatment apparatus comprising a water inlet port, a water outlet port and a fluid flow path extending from the water inlet port to the water outlet port, a filtration member comprising at least two containers each of which contains sand and at least one of the containers is removable from the apparatus.

2. The water treatment apparatus as claimed in claim 1 wherein each of the containers is removable from the water treatment apparatus.

3. The water treatment apparatus as claimed in claim 1 wherein each of the containers is removable from the water treatment apparatus.

4. The water treatment apparatus as claimed in claim 1 wherein each of the containers is individually removable from the water treatment apparatus.

5. The water treatment apparatus as claimed in claim 1 wherein the containers are configured to define a top container and the top container is the at least one of the containers the is removable.

6. The water treatment apparatus as claimed in claim 1 wherein the containers are connected if flow communication that the water to be treated flows sequentially through the containers.

7. The water treatment apparatus as claimed in claim 1 wherein each of the containers that is removable has a water inlet port and a water outlet port and each of the containers that is removable include a water inlet port sealing member and a water outlet port sealing member.

8. The water treatment apparatus as claimed in claim 7 wherein the water inlet port sealing member and the water outlet port sealing member automatically seal the inlet and outlet ports when the container is removed from the apparatus.

9. The water treatment apparatus as claimed in claim 1 wherein the containers are configured to define a top container and the top container is provided with biological material in a cartridge which is openable.

10. The water treatment apparatus as claimed in claim 1 wherein biological material in a cartridge which is openable is provided in at least one container.

11. The water treatment apparatus as claimed in claim 1 wherein biological material to promote the formation of schmutzdecke is provided in at least one container.

12-21. (canceled)

22. A water treatment apparatus comprising a water inlet port for receiving water at a pressure, a water outlet port and a fluid flow path extending from the water inlet port to the water outlet port, a filtration member comprising at least one bed of sand, a purification member downstream from the bed of sand and a storage vessel which is at a pressure less than the pressure at the water inlet port.

23. The water treatment apparatus as claimed in claim 22 wherein the storage vessel is at about atmospheric pressure.

24. The water treatment apparatus as claimed in claim 22 wherein further comprising a pump downstream from the storage vessel.

25. The water treatment apparatus as claimed in claim 22 wherein the bed of sand is provided in a plurality of containers, at least one of which is removable from the apparatus.

26. The water treatment apparatus as claimed in claim 22 wherein the containers that are removable from the apparatus are sealable.

27. The water treatment apparatus as claimed in claim 26 wherein at least one of the containers is provided with biological material to promote the formation of a schmutzdecke.

28. The water treatment apparatus as claimed in claim 26 further comprising a biological material to promote the formation of a schmutzdecke.

29. The water treatment apparatus as claimed in claim 22 wherein the purification step comprises at least one of ozonation, exposure to UV radiation or passing the water through a carbon filter.

30. The water treatment apparatus as claimed in claim 22 further comprising a sensor to determine the water level in the storage vessel and a valve drivenly connected to the sensor whereby the valve terminates the flow of water through the apparatus.

31. A water treatment apparatus comprising a water inlet port for receiving water at a pressure, a water outlet port and a fluid flow path extending from the water inlet port to the water outlet port, a filtration member comprising at least one bed of sand, a purification member downstream from the bed of sand, a storage vessel, a sensor to determine the water level in the storage vessel and a valve drivenly connected to the sensor whereby the valve terminates the flow of water through the apparatus.

32. The water treatment apparatus as claimed in claim 31 wherein the sensor and the valve comprise a float valve.

33. The water treatment apparatus as claimed in claim 31 wherein the purification member is positioned in the storage vessel.

34. The water treatment apparatus as claimed in claim 31 wherein the purification member is actuated by a second water level sensor.

35. The water treatment apparatus as claimed in claim 31 wherein the purification member uses ozonation and an ozone generator is actuated by a second sensor to determine the water level in the storage vessel.
